(19) United States
(12) Patent Application Publication
(10) Pub. No.: US 2007/0277122 A1
(43) Pub. Date: Nov. 29, 2007

(54) Singular, persistent user experience for reviewing and initiating multi-action processes

(75) Inventors: Naud Frijlink, Redmond, WA (US); Scott J. Garsed-Donnelly, Georgetown, TX (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/441,781

(22) Filed: May 26, 2006

(51) Int. Cl. G06F 17/00

(52) U.S. Cl. 715/854; 715/772; 715/853; 715/771

(57) ABSTRACT

Administrative or other complex tasks are presented in a single user interface. Each subtask may have an expandable interface through which a user may edit parameters prior to execution or monitor progress of an ongoing set of processes related to that subtask. When a subtask is completed, error messages, status items, or optional subsequent operations may be presented to the user through the expandable portion, or the expandable portion may be collapsed when no such messages or status is to be shown. The user interface may also include a progress bar for the overall progress of the subtasks, as well as progress bars for each individual subtask. The single user interface may be used prior to execution as well as monitoring the progress of execution and post-execution status and follow-on operations. The user interface may be especially suited for administrative tasks performed by a computer.

### BACKGROUND

Many tasks may consist of multiple steps, be they tasks that are performed by a computer or tasks performed by people, such as employees or subordinates. Tasks may be grouped in subtasks, each of which may be further broken down into a sequence of steps that need to occur to perform a subtask. Sometimes the tasks may be performed in series and sometimes in parallel. Because the entire task may consist of many such subtasks, the complexity of the entire sum of the task may be difficult to communicate to a person, and difficult for the person to navigate and define the tasks prior to execution, as well as monitor the tasks during execution, and receive feedback afterwards.

By way of example, administrative tasks on a computer, such as installing software or configuring a system or subsystem, sometimes require many computer operations that may be grouped into subtasks. The user may need to enter several configuration parameters, then several computer processes may be started that perform the configuration or installation. The subtasks may be performed serially or in parallel. As the complexity of the overall task increases, there may be difficulty in presenting the information to the user prior to execution, during execution, and afterwards.

### SUMMARY

Administrative or other complex tasks are presented in a single user interface wherein the task is broken into subtasks. Each subtask may have an expandable interface through which a user may edit parameters prior to execution or monitor progress of an ongoing set of processes related to that subtask. When a subtask is completed, error messages, status items, or optional subsequent operations may be presented to the user through the expandable portion, or the expandable portion may be collapsed when no such messages or status are to be shown. The user interface may also include a progress bar for the overall progress of the subtasks, as well as progress bars for each individual subtask. The single user interface may be used prior to execution as well as monitoring the progress of execution and post-execution status and follow-on operations. The user interface may be especially suited for administrative tasks performed by a computer.

### BRIEF DESCRIPTION OF THE DRAWINGS

In the drawings,

FIG. 1 is a pictorial illustration of an embodiment showing a user interface with subtasks prior to execution.

FIG. 2 is a pictorial illustration of an embodiment showing a user interface with subtasks during execution.

FIG. 3 is a pictorial illustration of an embodiment showing a user interface with subtasks after execution.

FIG. 4 is a flowchart illustration of a method for displaying portions of a task prior to, during, and after execution.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

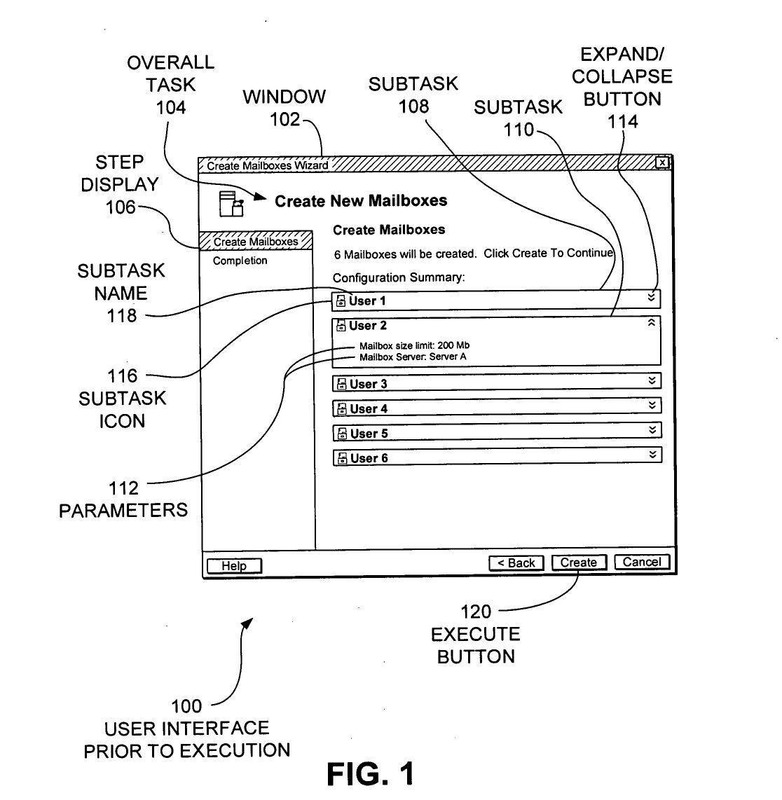

FIG. 1 is a pictorial representation of an embodiment 100 showing a user interface for the management of a task. The window 102 displays the overall task 104 that is grouped into steps 106 that comprise various subtasks 108 and 110 among others. Each subtask may have several parameters 112 associated with the subtask. The subtask 108 is shown in a collapsed view, while subtask 110 is shown in an expanded view. The expanded and collapsed views may be toggled by operating the expand/collapse button 114. Each subtask may have a subtask icon 116 and a name 118. The execute button 120 may begin executing the various subtasks.

The embodiment 100 is an example of a user interface for a task that has several subtasks. The subtasks may be presented in an expanded or collapsed view, and the user interface may stay relatively similar throughout the preparation, execution, and post-execution review of the subtasks. The user experiences a single, unified view throughout the entire task so that the user does not have to reorient at various stages.

The task to be performed may be any task that can be broken down into subtasks. In some instances, the subtasks may be performed in parallel or in serial. The various subtasks may be any type of independent action, such as a subtask assigned to an employee in a business situation, a project given to a military squadron, a process executed by the computer displaying the window 102, or a computer process executed on another computer connected on a network. For the purposes of illustration only, the present embodiment shows several computer processes that are organized as subtasks. Those skilled in the art will appreciate that the present embodiment may be applied to any type of task management situation where a task may be broken into subtasks.

In the present embodiment, the overall-task 104 is to create new mailboxes. The task may be broken down into subtasks that may be grouped as steps 106. In some applications, the various steps may be groupings of tasks that should be performed in sequence. In the present embodiment, the groupings merely comprise “Creating Mailboxes” and “Completion”. In other embodiments, the groupings might include “Create Accounts”, “Create Mailboxes”, “Set Permissions”, “Verify Accounts”, or any other related groupings of tasks.

In some embodiments, steps 106 may be the high level actions or statuses that the subtasks may take during the course of performing the overall task. For example, the first step applied to the subtasks may include creating several accounts, each of which could be assigned a separate subtask. As the accounts are initiated, mailboxes are created, the permissions are set, and the accounts verified, the subtask associated with a particular account may be displayed as subtasks 108 and 110. During the various steps, similar operations may be performed on each subtask.

The various subtasks may undergo a series of steps from initialization to completion. In the first step, each of the subtasks may be executed to a particular stopping point, then the next step displayed on the step display 106 may be performed on each subtask. Certain high level tasks may be suited to such an incremental process while other tasks may not be.

The embodiment 100 enables a user to expand and collapse the views of various subtasks. When a subtask is expanded, such as subtask 110, various parameters 112 may be displayed. The parameters 112 may be editable, where the user may change a setting by clicking on a button, manipulating a slider, changing text, or any type of parameter change using any mechanism. In some embodiments, a default set of parameters may be used when a subtask is created or defined. In other embodiments, a user may be required to enter or select parameters before the subtask is defined. The parameters 112 may be any variable that may be used during the execution of the subtask 110.

The expanded and collapsed views of the various subtasks may enable a user to browse many subtasks in a relatively small area. When a user encounters a particular subtask of interest, the expand/collapse toggle button 114 may be engaged and enable the user to view or edit parameters that affect that subtask. In the case of an administrative task performed by a computer, the parameters 112 may be variables that are used by the computer process that accomplishes the specific subtask. When the task is performed by subordinates or other personnel, the parameters 112 may be messages or other communication that is passed to the personnel, or may be merely notes or reminders about the subtask.

In some embodiments, the expanded view of a subtask may include links to web pages or to other actions that may be performed outside of the normal operation of the subtask. For example, a link may be provided that provides help or explanation. In another example, a link may cause a separate computer process to execute, such as a separate administrative task, a query to a database, or some other related process. Such a link may return a value that may be inserted as one of the parameters 112.

After the subtasks are ready for execution, the execute button 120 may be activated to begin execution of the subtasks. In some embodiments, the execute button 120 may not be active while one or more of the subtasks have incomplete or incorrect parameters 112. When this happens, the user may be required to correct or complete the offending parameters 112 before executing the subtasks. In some cases, the subtasks with incomplete or incorrect parameters 112 may be displayed in an expanded view.

Various embodiments may use different methods and techniques for showing an expanded or collapsed view of a subtask. In some cases, the transition between the expanded and collapsed views may be animated, for example. Subtasks may be presented in any way, shape, or manner whatsoever in an expanded or collapsed view.

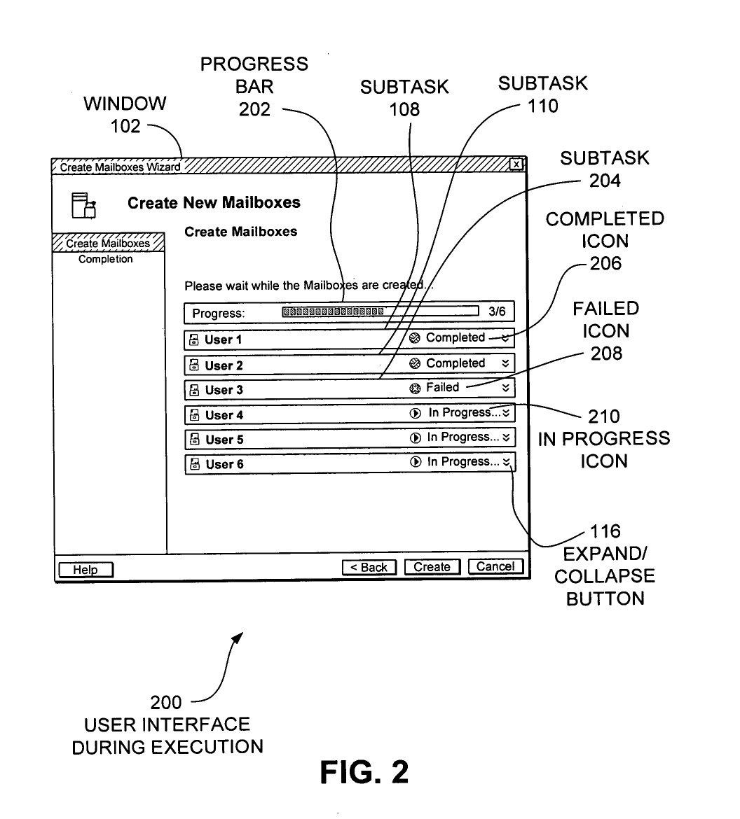

FIG. 2 illustrates an embodiment 200 of a user interface shown during the execution of a group of subtasks. The window 102 is the same window as in embodiment 100, with subtasks 108 and 110 and the expand/collapse button 116 identified. Because the subtasks may be executing during the view shown in embodiment 200, a progress bar 202 may illustrate the overall progress of the group of subtasks. Some of the subtasks may have a completed icon 206, a failed icon 208, or an in-progress icon 210. Subtask 204 is shown with a failed icon 208.

During the execution of the subtasks, one or more of the subtasks may be executed. In some cases, a subtask may depend on the completion of another subtask and in such a case, some or all of the subtasks may be performed in series. In other cases, the subtasks may be performed in parallel.

As the subtasks are executed, the progress bar 202 may keep track of the completion status of all of the subtasks as a group. A user may be able to quickly glance at the status to know when to expect to have the subtasks completed. Various information may be presented, such as an indicator bar, an estimated time remaining, a counter for the number of completed subtasks, or any other useful progress information.

While one or more of the subtasks are executing, a user may be able to engage the expand/collapse button 116 to view a more detailed status of the subtask during execution. For example, a user may be able to expand one of the currently executing subtasks to view the status of that particular subtask, view any error messages, change a parameter, or otherwise interact with the subtask.

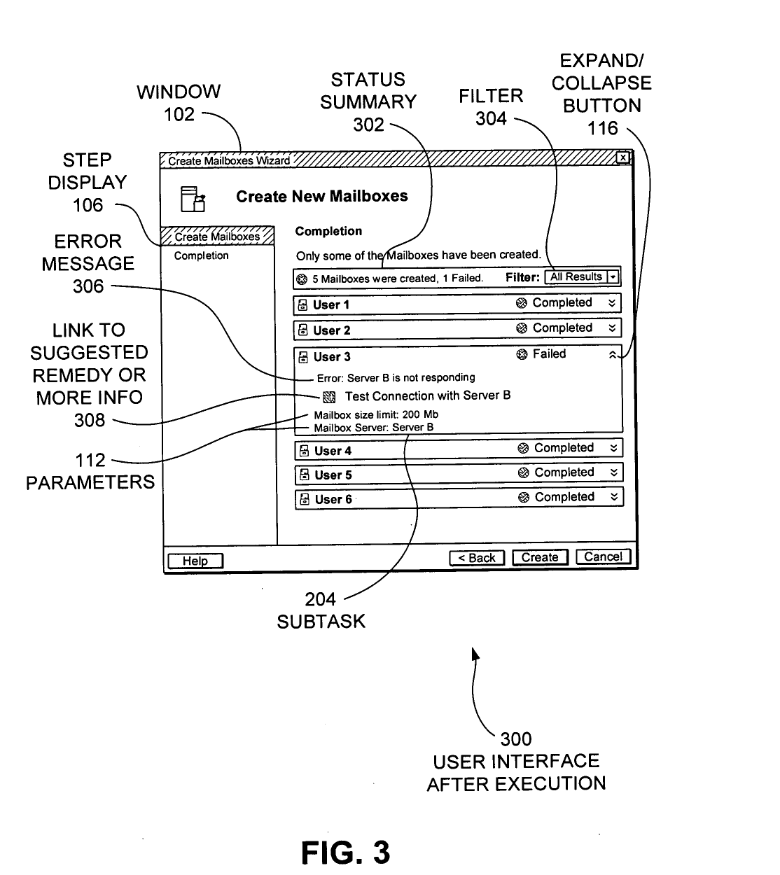

FIG. 3 illustrates an embodiment 300 showing a user interface after execution of the subtasks. The window 102 shows the step display 106, as well as subtask 204 with parameters 112, an expand/collapse button 116, an error message 306, and a link to a suggested remedy 308.

Embodiment 300 illustrates the final stage of subtask execution, when all of the subtasks have completed action and the results are viewed. The status summary 302 in this case shows that 5 mailboxes were created and 1 failed. The subtask that failed is displayed in an expanded view so that the user may take appropriate action or merely be notified of the details. The filter 304 may enable a user to selectively view a portion of the completed or attempted subtasks. Such a filter may be useful when the number of subtasks is much larger than what could be displayed on the screen at one time.

The failed subtask 204 in the expanded view shows an error message 306 that may summarize a problem that occurred during execution. The link 308 may cause another process to be executed. In the present embodiment, the link 308 may test a connection to server B. In other embodiments, the link 308 may cause a web page to be displayed that may give additional help or explanation on how to interpret the results.

In some embodiments, the user may be able to change the parameters 112 and re-execute the subtask. Since the other subtasks have been completed, they may not be re-executed when the failed subtask is retried.

The embodiments 100, 200, and 300 illustrate how a single window 102 may be used to set up, display, execute, and view results from a plurality of subtasks that are executed. In some cases, the subtasks may be processes executed by a computer, while in other cases, the processes may be subtasks performed by employees, military personnel, subcontractors, business partners, or any other entity. In some cases, the subtasks may represent computer processes executed on different computers dispersed on a network.

Throughout the steps of setting up, executing, and displaying results, the subtasks have a unified view. This enables a user to have a simple, known, and comfortable user interface during the entire task. The status of the subtasks are updated during the process of executing the task, but the general look and feel of the user interface is relatively constant. This enables a user to quickly perceive and view relevant information without causing the user to re-orient to a drastically changed view.

When a subtask is complete, either prior to executing or afterwards, the subtask may be displayed in a collapsed mode. The user may be able to expand the view of the subtask, check the status, edit parameters, or launch a related process at any time during the overall task. By keeping the subtask in a collapsed mode, more information may be presented to the user than if all of the subtasks were in an expanded view. Further, by only using an expanded view for subtasks that require user interaction, those subtasks may be visually highlighted with the necessary information for efficient user interaction.

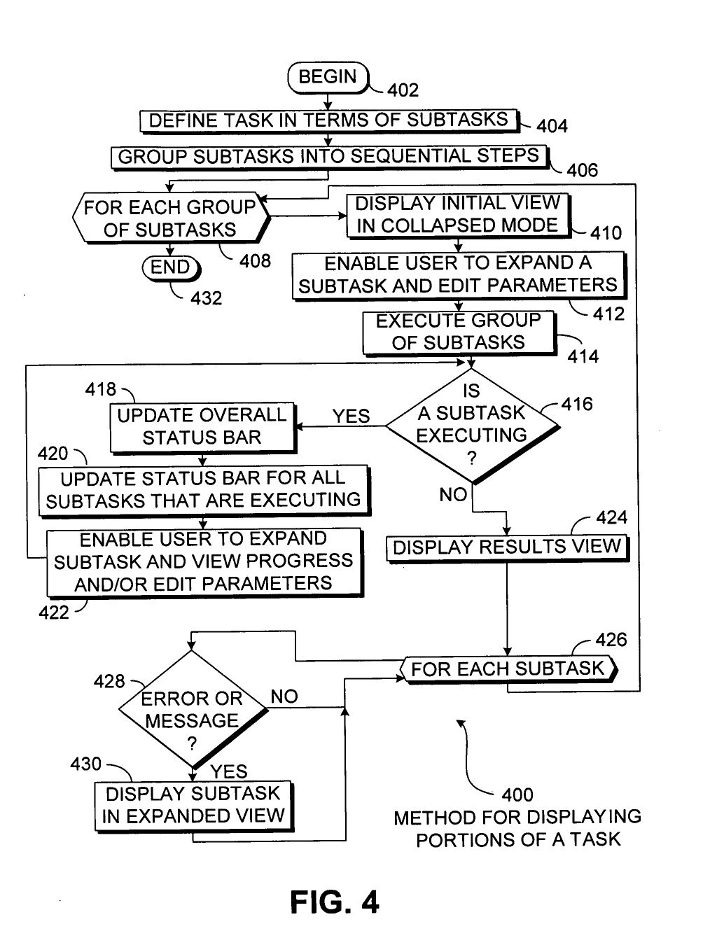

FIG. 4 illustrates a method for displaying portions of a task during the creation, execution, and results phases of subtasks. The process begins in block 402. The overall task is defined in terms of subtasks in block 404, and the subtasks may be grouped into sequential steps in block 406. For each group of subtasks in block 408, the initial view of a subtask may be displayed in a collapsed view in block 410, and a user may be able to expand a subtask and edit parameters relating to that subtask in block 412. Once the subtasks are ready for execution, they are executed in block 414.

If a subtask is executing in block 416, an overall status bar may be updated in block 418, as well as a status bar or other indicator for each individual subtask in block 420. While the subtasks are being executed, the user may be able to expand and collapse a view of a particular subtask to view progress and/or to edit parameters in block 422. When the subtasks are completed in block 416, the results of the subtask execution may be displayed in block 424.

For each subtask in block 426, if an error or other message is present in block 428, the subtask may be displayed in an expanded view in block 430. If no such error or message is present in block 428, the next subtask is evaluated in block 426 and the subtask is displayed in a collapsed view. After each group of subtasks is performed in block 408, the process ends in block 432.

The embodiment 400 is one method by which a common interface may be used to manage multiple subtasks that are part of a larger task. In some cases, the subtasks may be grouped into logical steps, where a first group of subtasks may be performed before a second group. Within each group, some subtasks may be performed in series while others may be performed in parallel.

The common interface used to display the subtasks may enable a user to expand and collapse each subtask. Prior to execution, the user may expand a subtask to edit or view various parameters. During execution, the user may expand a subtask to view a detailed status of the subtask during execution. After completion, the user may expand a subtask to view any error codes, messages, or completion results for the subtask.

In general, a subtask that has valid execution parameters and executes to successful completion may be presented to the user in a collapsed mode. As such, the subtask may not require much, if any, attention from the user. Subtasks that are incomplete, fail execution, or have other irregularities may be automatically or manually presented to the user in an expanded form. By keeping some subtasks collapsed, those may clear some space on a viewing window for the subtasks with which the user will interact.

The common interface enables a user to follow the progress of a group of subtasks from conception, through execution and results while keeping a common look and feel to the interface. As the user progresses through the overall task, the layout of the window may be consistent and intuitive, so that the user may pick up information at a glance without having to visually re-assimilate the visual picture to pick out relevant information.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A user interface comprising:
a grouping of a plurality of subtasks; and
a button operable to initiate the execution of said plurality of subtasks;
wherein the display of each of said subtasks comprises:
an expanded view;
a collapsed view;
an expand button operable to switch between said collapsed view to said expanded view;
a status indicator adapted to depict the completion of said subtask;
wherein said user interface is adapted to:
display said subtasks in an initial view, said initial view comprising at least one of said subtasks in said collapsed view;
display said status indicator for at least one of said subtasks when said subtask is being performed;
display at least one of said subtasks in said expanded view when an error occurs when said subtask is performed;
allow a user input with said expand button on one of said subtasks to show a detailed progress of one of said subtasks during the execution of said subtask.

2. The user interface of claim 1 wherein at least one of said subtasks is editable before execution.

3. The user interface of claim 1 further comprising a progress bar adapted to display the completion of all of said subtasks as a group.

4. The user interface of claim 1 wherein said expanded view comprises a link adapted to execute an additional computer process.

5. The user interface of claim 1 wherein said expanded view comprises an error message when said subtask is performed.

6. The user interface of claim 1 further comprising a step navigator comprising a grouping of said subtasks.

7. The user interface of claim 6 comprising a first grouping and a second grouping, said second grouping to be executed after the completion of said first grouping.

8. The user interface of claim 1 wherein said subtasks may be completed in parallel.

9. The user interface of claim 1 wherein at least two of said subtasks are completed in serial.

10. A method comprising:
defining a set of subtasks;
presenting said set of subtasks in a user interface, said user interface comprising:
a grouping of a plurality of subtasks; and
a start button operable to initiate the execution of said plurality of subtasks;
wherein the display of each of said subtasks comprises: an expanded view; a collapsed view; an expand button operable to switch between said collapsed view to said expanded view; a status indicator adapted to depict the completion of said subtask;
wherein said user interface is adapted to: display said subtasks in an initial view, said initial view comprising at least one of said subtasks in said collapsed view; display said status indicator for at least one of said subtasks when said subtask is being performed;
display at least one of said subtasks in said expanded view when an error occurs when said subtask is performed; allow a user input with said expand button on one of said subtasks to show a detailed progress of one of said subtasks during the execution of said subtask;
starting to execute said subtasks when a user interacts with said start button;
allowing said user to interact with said expand button of a first subtask and showing a detailed progress of said first subtask; and
presenting said subtasks in a completed state wherein a completed one of said subtasks is presented in said expanded view.

11. The method of claim 10 further comprising allowing said user to edit at least one of said subtasks prior to said starting to execute said subtasks.

12. The method of claim 10 further comprising displaying a progress bar adapted to display the completion of all of said subtasks as a group.

13. The method of claim 10 further comprising presenting a link adapted to execute an additional computer process within said expanded view.

14. The method of claim 10 further comprising presenting an error message in said expanded view of said completed one of said subtasks.

15. The method of claim 10 further comprising presenting a step navigator comprising a grouping of said subtasks, said step navigator being adapted to show the progression of completed and uncompleted groups of said subtasks.

16. The method of claim 15 further comprising completing a first grouping of said subtasks prior to completing a second grouping of said subtasks.

17. The method of claim 10 further comprising completing at least two of said subtasks in parallel.

18. The method of claim 10 further comprising completing at least two of said subtasks in series.

19. A computer readable medium comprising computer readable instructions to perform the method of claim 10.
